(19) United States
(12) Patent Application Publication
(10) Pub. No.: US 2007/0126230 A1
(43) Pub. Date: Jun. 7, 2007

(54) Device for connection to an end of a corrugated pipe

(75) Inventors: Axel Feger, Lorrach (DE); Martin Kurth, Weil am Rhein-Otlingen (DE); Daniel Utz, Bad Bellingen (DE); Matthias Kubel, Braunschweig (DE)

Correspondence Address: BAKER & DANIELS LLP;111 E. WAYNE STREET, SUITE 800, FORT WAYNE, IN, 46802, US

(73) Assignees: A. RAYMOND & CIE, Grenoble (FR); VOLKSWAGEN AKTIENGESELLSCHAFT, Wolfsburg (DE)

(21) Appl. No.: 10/596,271

(22) PCT Filed: Nov. 25, 2004
(86) PCT No.: PCT/EP04/13353

§ 371 Date: Jan. 22, 2007

(30) Foreign Application Priority Data
Dec. 11, 2003 (DE) 10357892.7

(51) Int. Cl. F16L 33/00

(52) U.S. Cl. 285/242

(57) ABSTRACT

A connector for connecting to an end of a corrugated conduit. An infitting section can be inserted into the end of a corrugated conduit and has at least one conical section which is provided with a ramp surface that slopes upward in the insertion direction, pointing away from the infitting end. A clamp is spaced radially apart from the infitting section and includes at least one engaging nose which can be inserted between two elevations of the corrugated conduit.

The invention concerns a device for connection to an end of a corrugated pipe.

A device for connection to an end of a corrugated pipe is known from U.S. Pat. No. 5,335,945. This device comprises a receiving section, made of a flexible, stretchable plastic material, into which an end of a corrugated pipe can be slid, radially stretching the receiving section, until contact is made with a stopping flange. The corrugated pipe is sealingly connected to the device by the radially inward compressive force that the receiving section exerts on the end of the corrugated pipe.

Although with this prior-art device an end of a corrugated pipe can be connected to a fluid conducting system via a connecting section of the device, nevertheless, owing to the contradictory requirements, i.e., the greatest possible compressive force in order to create a seal, and for handling reasons the lowest possible force necessary for insertion, it can be configured for practice only by way of a compromise that is not always operationally reliable.

The object of the invention is to create a device for connection to an end of a corrugated pipe that is distinguished by ease of handling while exhibiting extreme tightness.

This object is achieved according to the invention by means of a device for connection to an end of a corrugated pipe, comprising an infitting section that can be inserted into the end of the corrugated pipe and has at least one conical section provided with a ramp surface that slopes upward in an insertion direction pointing away from an infitting end, and comprising a clamping arrangement spaced radially apart from the infitting section and provided with at least one engaging nose that can be fitted in between two elevations of the corrugated pipe.

Providing the conical section configured with the ramp surface makes it possible to slide an end of a corrugated pipe sealingly onto the infitting section, spreading the pipe slightly, and connect it to the device in an operationally reliable manner by means of at least one clamping arrangement configured as an engaging nose.

Advantageous improvements are the subject matter of the dependent claims.

Further suitable configurations and advantages of the invention are the subject matter of the following description of exemplary embodiments, provided with reference to the figures of the drawing. Therein:

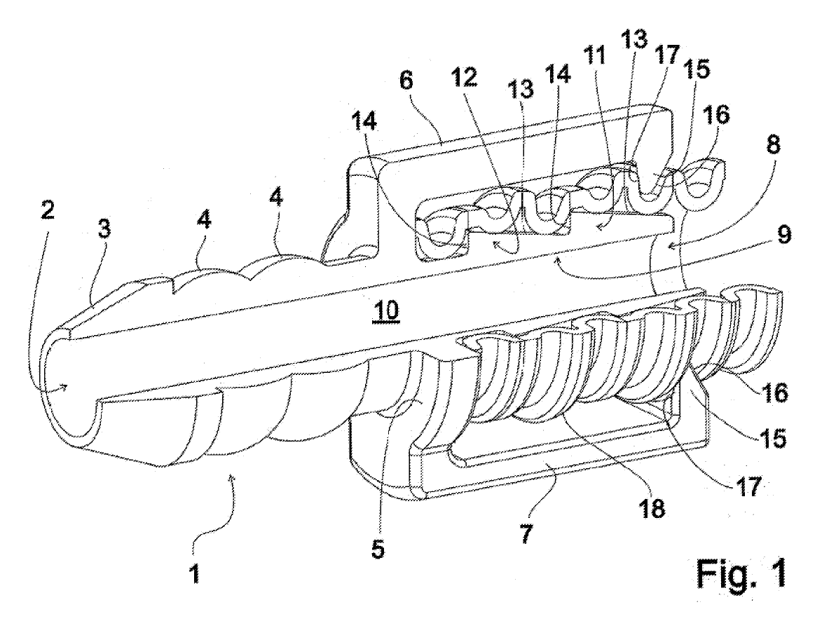

FIG. 1 is a partially cut-away perspective view of a first exemplary embodiment of the invention,

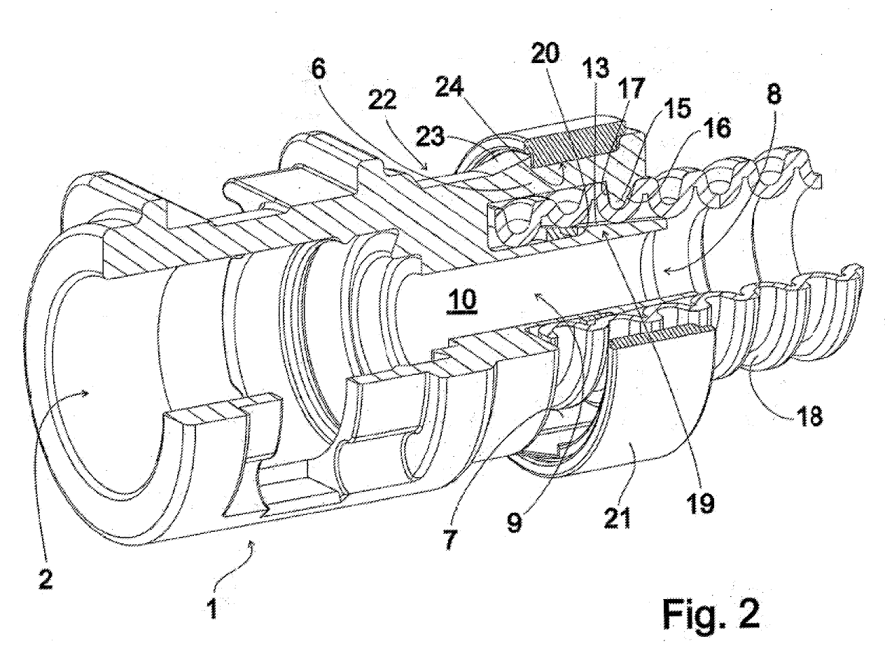

FIG. 2 is a partially cut-away perspective view of a second exemplary embodiment of the invention, and

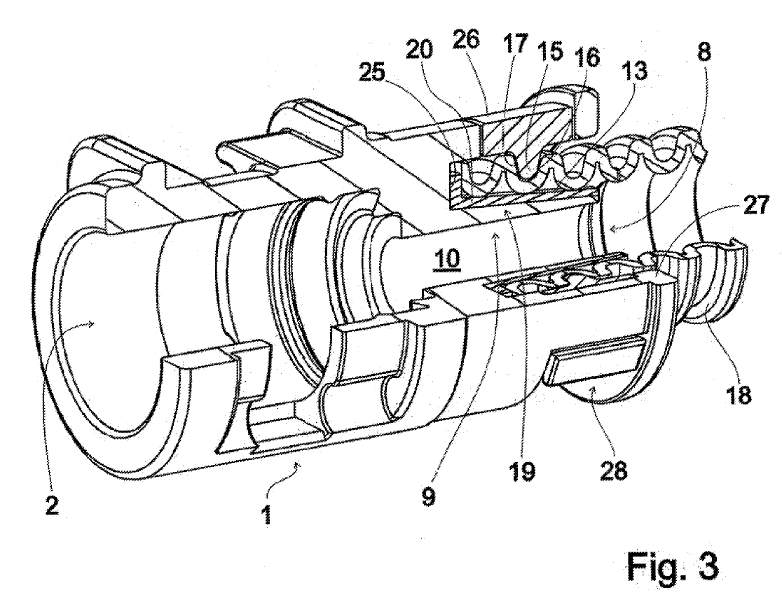

FIG. 3 is a partially cut-away perspective view of a third exemplary embodiment of the invention.

FIG. 1 shows a first exemplary embodiment of an inventive device in a partially cut-away perspective view. The exemplary embodiment of FIG. 1 comprises an elongated connecting section 1 configured at a plug-in end 2 with a plug-in cone 3 that tapers down in the direction of plug-in end 2. Configured on the side of plug-in cone 3 away from plug-in end 2 are a number of roundish sealing bulges 4, which give connecting section 1 a radial cross section that undulates between a maximum and a minimum value in the longitudinal direction of connecting section 1. Connecting section 1 serves to connect the device for example to a smooth-walled tube of a fluid conducting system, not illustrated in FIG. 1.

Configured roughly in the midregion of the device according to FIG. 1 is an annular collar 5, which projects radially past the maximum diameter of sealing bulge 4 and thereby forms a stop from the standpoint of plug-in end 2. Joined to the outside of annular collar 5, diametrically opposite each other in the exemplary embodiment of FIG. 1, are a resilient first clamping bracket 6 and a resilient second clamping bracket 7 of a clamping arrangement, which extend in the direction of an infitting end 8 opposite plug-in end 2. In addition, an elongated infitting section 9 extends from annular collar 5 in the direction of infitting end 8 in prolongation of plug-in end 2. As can be seen from FIG. 1, clamping brackets 6, 7 are substantially parallel and are disposed in spaced relation to infitting section 9. Connecting section 1 and infitting section 9 enclose a fluid channel 10 that extends from plug-in end 2 to infitting end 8.

Configured on the outer side of infitting section 9 in the vicinity of infitting end 8 in the exemplary embodiment of FIG. 1 are a first conical section 11 and, between first conical section 11 and annular collar 5, a second conical section 12. Each conical section 11, 12 is provided with a ramp surface 13 that slopes upward relatively shallowly in an infitting direction from infitting end 8, and with a retaining surface 14 adjoining the associated ramp surface 13 and facing annular collar 5. The retaining surfaces 14 are set at a much steeper angle to the longitudinal axis than the ramp surfaces 13, for example perpendicular to the longitudinal axis of the device as in the exemplary embodiment of FIG. 1.

Each of clamping brackets 6, 7 is provided at its free end, located in the region of infitting end 8, with an inward-pointing engaging nose 15, configured with a sliding surface 16 that faces infitting end 8 and is beveled radially inwardly from infitting end 8 in the direction of annular collar 5, and with a stop surface 17 that faces away from infitting end 8 and is oriented substantially perpendicularly to the longitudinal axis of the device.

Finally, depicted in FIG. 1 is an end of a corrugated pipe 18 whose wall is configured in the longitudinal direction with a sequence of radially oriented elevations and depressions. In the representation of FIG. 1, the end of corrugated pipe 18 is slid over infitting section 9 until it is stopped by annular collar 5, causing the regions of the wall that are closest radially to the longitudinal axis of corrugated pipe 18 to rest against the ramp surfaces 13 of conical sections 11, 12 and be expanded slightly over the original inner diameter. The resultant radially inwardly acting force achieves the effect of sealing corrugated pipe 18 with respect to infitting section 9.

It is further apparent from FIG. 1 that when stop surfaces 17 are resting against radially inwardly sloping wall sections of corrugated pipe 18, the engaging noses 15 extend behind a radially outwardly protruding elevation of the wall of corrugated pipe 18, having ridden radially outwardly over a number of radially outwardly protruding elevations of the wall of corrugated pipe 18 as corrugated pipe 18 is fitted in¹, bending resilient clamping brackets 6, 7 upward in the process. Corrugated pipe 18 is thereby protected against being accidentally pulled out of the device.
TRANSLATOR'S NOTE: I.e., fitted inside the brackets.

FIG. 2 shows a second exemplary embodiment of the invention in a partially cut-away perspective view; analogous elements in the exemplary embodiments of FIGS. 1 and 2 have been given the same reference numerals and will not be explained further if identical.

Connecting section 1 of the exemplary embodiment according to FIG. 2 is configured to be duct-like and is provided with a number of inner as well as outer elevations and depressions adapted to receive and arrest a coupling piece (not shown in FIG. 2) for connection to a fluid conducting system.

Infitting section 9 of the exemplary embodiment according to FIG. 2 is provided with a single conical section 19 having an inclined ramp surface 13 corresponding to the exemplary embodiment of FIG. 1. In the exemplary embodiment depicted in FIG. 2, the side of ramp surface 13 directed away from infitting end 8 is in contact with a rubber-like sealing body 20 that annularly surrounds infitting section 9. This brings about particularly good sealing of corrugated pipe 18 when a radially inwardly directed elevation in the wall of corrugated pipe 18 bears against sealing body 20.

It can also be seen from FIG. 2 that in this exemplary embodiment the clamping arrangement is provided with an annular, closed sliding bushing 21 that can be displaced axially, clamping brackets 6, 7 simultaneously deflecting radially, out of a releasing depression 22 (unoccupied in the representation of FIG. 2), over a slipping surface 23 that slopes upward shallowly in the direction of infitting end 8, and into an arresting depression 24 provided in clamping brackets 6, 7 in the region of engaging noses 15. Clamping brackets 6, 7 are thereby protected against expanding radially outward. Arresting depression 24 is provided with substantially radially oriented boundary sides, so that once sliding bushing 21 has been snapped into arresting depression 24, it can be removed from arresting depression 24 only after deliberate and relatively complex manipulation. In this way it is virtually impossible to overcome the arrestation produced by engaging noses 15, even by comparatively strenuous movements of the corrugated pipe 18 in the region of infitting end 8.

FIG. 3 illustrates a third exemplary embodiment of the invention in a partially cut-away perspective view; corresponding elements in the exemplary embodiments according to FIGS. 1, 2 and 3 have been given the same reference numerals and will not be explained further below. The exemplary embodiment of FIG. 3, like that of FIG. 2, comprises a connecting section 1 that is configured as duct-like and is provided with a number of both inner and outer elevations and depressions arranged to receive and arrest a coupling piece (not shown in FIG. 3) for connection to a fluid conducting system.

In the exemplary embodiment of FIG. 3, infitting section 9 is configured over its entire length with a conical ramp surface 13 of a single conical section 19, which ramp surface slopes upward in a direction heading away from infitting end 8 and ends in a radially oriented terminating surface 25. Pushed onto ramp surface 13 and most of terminating surface 25 is a rubber-like sealing body 20, on which a number of radially inwardly projecting elevations of the wall of a corrugated pipe 18 come to rest.

In the exemplary embodiment of FIG. 3, the clamping arrangement for securing corrugated pipe 18 includes a C-shaped snap ring 26, which can be fitted, in a radially oriented direction of insertion, into an annular seat 28 provided in the region of infitting end 8 and terminated marginally by a terminating flange 27. Snap ring 26 is provided radially inwardly with a circumambient engaging nose 15, which, when snap ring 26 is arranged as intended, extends for a relatively large proportion of the circumference behind a radially outwardly projecting elevation of the wall of corrugated pipe 18. Corrugated pipe 18 is thereby protected against accidentally being pulled out of the inventive device.

1-6. (canceled)

7. A connector for connecting to the end of a corrugated conduit, said corrugated conduit including a plurality of elevated corrugations, said connector comprising:
an elongated connector portion adapted for insertion into a said end of a said corrugated conduit, said connector having a longitudinal axis, said connector portion having first and second ends, said connector portion having a conical section located proximate said first end, said conical section including a ramp surface which slopes radially outwardly in the direction of said second end;
a clamp spaced radially from said first end, said clamp including an engaging nose which is adapted to move into a clamping position wherein said nose fits between two of said elevated corrugations to thereby prevent said conduit from being separated from said conduit.

8. The connector according to claim 7 wherein said connector portion further includes a radially outwardly extending retaining surface adjacent said ramp surface, said retaining surface facing said second end and being directed at a greater angle relative to said longitudinal axis of said connector portion than said ramp surface.

9. The connector of claim 8 including two ramp surfaces and two retaining surfaces.

10. The connector of claim 7 further including an annular elastic sealing body surrounding said connector portion for sealing a said corrugated conduit to said connector.

11. The connector of claim 7 wherein said clamp comprises two clamping brackets disposed parallel to said longitudinal axis on respective opposite sides of said connector portion, one of said brackets including said engaging nose.

12. The connector according to claim 7 further including a sliding bushing surrounding said connector portion, said sliding bushing movable from a release position to a locking position wherein said engaging nose is prevented from moving out of said clamping position.

13. The connector according to claim 7 wherein said clamp comprises a C-shaped snap ring, said C-shaped snap ring including said engaging nose on an inner face thereof, a depression located in an outer surface of said connector, said snap ring adapted to be disposed into said depression.
